(19) United States
(12) Patent Application Publication
(10) Pub. No.: US 2026/0330227 A1
(43) Pub. Date: Oct. 22, 2026

(54) NEURAL COMPACT MODELING METHOD AND COMPUTING DEVICE

(71) Applicant: ALSEMY INC., Seoul (KR)

(72) Inventors: Ye Sle CHA, Seoul (KR); Jung Hwan PARK, Seoul (KR); Hyun Seok HWANG, Seoul (KR)

(73) Assignee: ALSEMY INC., Seoul (KR)

(21) Appl. No.: 19/115,663

(22) PCT Filed: Dec. 1, 2022
(86) PCT No.: PCT/KR2022/019333

§ 371 Date: Mar. 26, 2025

(30) Foreign Application Priority Data
Sep. 27, 2022 (KR) 10-2022-0122541

(51) Int. Cl. G06N 3/084

(52) U.S. Cl. CPC G06N 3/084

(57) ABSTRACT

A neural compact modeling method performed by a processor is disclosed. The neural compact modeling method comprises the steps of: extracting a second vector for a second voltage dataset of a source device according to a first vector, which is extracted by applying, to an encoder, a first voltage dataset of the source device and a first current; comparing a second current, which is output by applying the second vector to a decoder, with a ground truth to train the encoder and the decoder; generating a third vector by using a third voltage dataset of a target device, a third current, and the trained encoder; and estimating a fourth current for a fourth voltage dataset of the target device by using the third vector, the trained encoder, and the trained decoder.

### TECHNICAL FIELD

The present invention relates to a neural compact modeling method and a computing device, and more specifically, to a neural compact modeling method and a computing device using a meta-learning technique.

### BACKGROUND ART

A single semiconductor chip is implemented using a plurality of transistors. In a process of designing a single semiconductor chip, a netlist describing the connectivity between transistors, capacitors, and resistors is generated. The netlist and a compact model are used in a simulator, such as a simulation program for integrated circuit emphasis (SPICE), to simulate the operation of each of the transistors. The compact model is a simple mathematical description of the behavior of circuit elements that constitute a single semiconductor chip.

The existing semiconductor element modeling method (Korean Patent No. 10-2285516) required a large number of datasets to train a neural network. Therefore, a significant amount of time and cost is needed to obtain a large number of datasets.

### DISCLOSURE

### Technical Problem

The present invention is directed to providing a neural compact modeling method and a computing device that are capable of performing neural compact modeling on a semiconductor device, which is a target device, using a limited amount of data of the target device.

### Technical Solution

A neural compact modeling method, which is performed by a processor according to an embodiment of the present invention includes: extracting a second vector for a second voltage data set of a source device according to a first vector extracted by applying a first voltage data set and a first current of the source device to an encoder; comparing a second current output by applying the second vector and the second voltage data set to a decoder with a ground truth to train the encoder and the decoder; generating a third vector using a third voltage data set and a third current of a target device, and the trained encoder; and estimating a fourth current for a fourth voltage data set of the target device using the third vector, the trained encoder, and the trained decoder.

The encoder may include: an initial vector generation module that generates an initial vector of the first vector or the second vector, an updater module that compares the first voltage data set, the first vector, and the first current to output an update value of the first vector; and an attention module that compares the first voltage data set with the second voltage data set to output an updated second vector from the update value of the first vector.

The extracting of the second vector may include: applying the first voltage data set to a first neural network of the encoder to generate a first initial vector; applying the second voltage data set to the first neural network of the encoder to generate a second initial vector; applying the first current, the first voltage data set, and the first initial vector to a second neural network of the encoder to output an update value of the first vector; setting an update value of the second initial vector as the update value of the first vector to output an update value of the second vector; applying the update value of the first vector and the first voltage data set to a third neural network of the encoder to update the first initial vector and output an updated first vector; and applying the first voltage data set, the second voltage data set, and the update value of the second vector to the third neural network of the encoder to update the second initial vector and output an updated second vector.

The neural compact modeling method may further include: performing a first output operation of applying the first current, the first voltage data set, and the updated first vector to the second neural network of the encoder to output a re-update value of the first vector; performing a second output operation of setting a re-update value of the updated second vector as the re-update value of the first vector to output the re-update value of the second vector; performing a third output operation of applying the re-update value of the first vector and the first voltage data set to the third neural network of the encoder to re-update the updated first vector and output the re-updated first vector; and performing a fourth output operation of applying the first voltage data set, the second voltage data set, and the re-updated value of the second vector to the third neural network of the encoder to re-update the updated second vector and outputting the re-updated second vector.

The first output operation, the second output operation, the third output operation, and the fourth output operation may be repeatedly performed an arbitrary number of times.

The second vector may be expressed by compressing data on a width, a length, and a temperature of the source device.

The second vector may be a function that may map the second voltage data set to data on a width, a length, and a temperature of the source device.

The second voltage data set may be a drain-source voltage, a gate-source voltage, and a bulk-source voltage.

In a process of extracting the second vector, parameters of the encoder and parameters of the decoder may not be updated.

The generating of the third vector may include: applying the third voltage data set to a first neural network of the trained encoder to generate a third initial vector; applying the fourth voltage data set to the first neural network of the trained encoder to generate a fourth initial vector; applying the third current, the third voltage data set, and the third initial vector to a second neural network of the trained encoder to output an update value of the third vector; setting an update value of the fourth initial vector as the update value of the third vector to output an update value of a fourth vector; and applying the update value of the third vector and the third voltage data set to a third neural network of the trained encoder to update the third initial vector and output an updated third vector.

The estimating of the fourth current may include: outputting an updated fourth vector using the third voltage data set, the fourth voltage data set, and the third vector; and applying the updated fourth vector to the trained decoder to estimate the fourth current for the fourth voltage data set of the target device.

A computing device according to an embodiment of the present invention includes a memory that stores instructions and a processor that executes the instructions.

The instructions are implemented to: extract a second vector for a second voltage data set of a source device according to a first vector extracted by applying a first voltage data set and a first current of the source device to an encoder; compare a second current output by applying the second vector and the second voltage data set to a decoder with a ground truth to train the encoder and the decoder; generate a third vector using a third voltage data set and a third current of a target device, and the trained encoder; and estimate a fourth current for a fourth voltage data set of the target device using the third vector, the trained encoder, and the trained decoder.

### Advantageous Effects

The neural compact modeling method and computing device according to embodiments of the present invention have the effect of generating an accurate neural compact model of a semiconductor device, which is a target device, even with a limited amount of data of the target device using a meta-learning technique.

### DESCRIPTION OF DRAWINGS

In order to more fully understand the drawings cited in the detailed description of the present invention, a detailed description of each drawing is provided.

FIG. 1 illustrates a block diagram of a computing device for performing a neural compact modeling method according to an embodiment of the present invention.

FIG. 2 illustrates a block diagram of a neural network for performing a neural compact modeling method according to an embodiment of the present invention.

FIG. 3 illustrates a flowchart for describing a neural compact modeling method according to an embodiment of the present invention.

FIG. 4 illustrates an internal block diagram of an encoder of a neural network for a source device shown in FIG. 2.

FIG. 5 illustrates a flowchart for describing in detail an operation of extracting a second vector shown in FIG. 3.

FIG. 6 illustrates an internal block diagram of an encoder of a neural network for a target device shown in FIG. 2.

FIG. 7 illustrates a flowchart for describing in detail an operation of extracting a third vector shown in FIG. 3.

FIG. 8 illustrates a flowchart for describing in detail an operation of estimating a fourth current shown in FIG. 3.

### MODES OF THE INVENTION

Specific structural and functional details disclosed herein are merely representative for purposes of describing embodiments according to the concept of the present disclosure. Accordingly, the embodiments according to the concept of the present disclosure may be embodied in many alternate forms. The present disclosure should not be construed as limited to the embodiments of the present disclosure set forth herein.

While the embodiments according to the concept of the present disclosure are susceptible to various modifications and alternative forms, specific embodiments thereof are shown by way of embodiment in the drawings and will herein be described in detail. It should be understood, however, that there is no intent to limit the embodiments according to the concept of the present disclosure to the particular forms disclosed, but on the contrary, the embodiments according to the concept of the present disclosure are to cover all modifications, equivalents, and alternatives falling within the spirit and scope of the invention.

It will be understood that, although the terms “first,” “second,” etc., may be used herein to describe various elements, these elements should not be limited by these terms. These terms are only used to distinguish one element from another. For example, a first element could be termed a second element, and, similarly, a second element could be termed a first element, without departing from the scope of the present invention.

It will be understood that when a first element is referred to as being “connected” or “coupled” to a second element, the first element can be directly connected or coupled to the second element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a” and “an” are intended to include the plural forms as well, unless the context clearly indicates otherwise. It will be further understood that the terms “comprise,” “comprising,” “include” and/or “including” used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meanings as commonly understood by those of ordinary skill in the art to which this invention belongs. It will be further understood that terms, such as those defined in commonly used dictionaries, should be interpreted as having meanings that are consistent with their meanings in the context of the relevant art and will not be interpreted in an idealized or overly formal sense unless expressly so defined herein.

Hereinafter, the present invention will be described in detail by describing a preferred embodiment of the present invention with reference to the accompanying drawings.

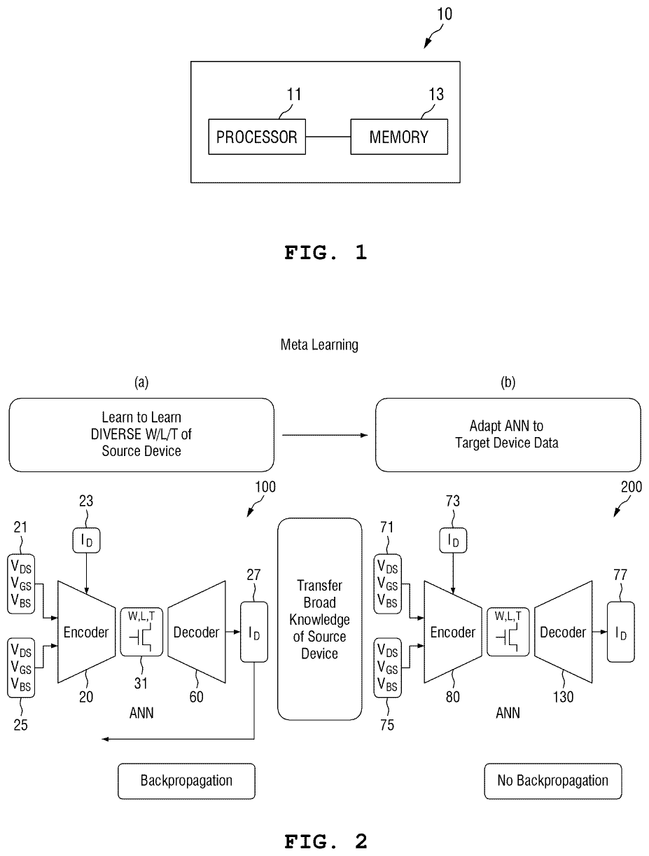

FIG. 1 illustrates a block diagram of a computing device for performing a neural compact modeling method according to an embodiment of the present invention.

Referring to FIG. 1, a computing device 10 for performing a neural compact modeling method may generate an accurate neural compact model of a semiconductor device, which is a target device, even with a limited amount of data of the target device using a meta-learning technique. The computing device 10 may be an electronic device, such as a server, a computer, a laptop, a tablet PC, or a personal PC. The computing device 10 includes a processor 11 and a memory 13. The processor 10 executes instructions in which the neural compact modeling method is implemented. The memory 13 stores instructions for implementing the neural compact modeling method. Hereinafter, a specific neural compact modeling method will be disclosed. The neural compact modeling method involves generating a compact model using a neural network.

FIG. 2 illustrates a block diagram of a neural network for performing a neural compact modeling method according to an embodiment of the present invention.

Referring to FIGS. 1 and 2, a neural network 100 is a neural network for a source device. The source device is a semiconductor device having a significant amount of data about voltage datasets 21 and 25 and drain currents 23 and 27.

A neural network 200 is a neural network for a target device. The target device is a semiconductor device corresponding to a drain current 77 that is desired to be known for a voltage dataset 75. The semiconductor device may be a transistor.

The purpose of the present invention is to predict the drain current of the target device using a neural compact modeling method. That is, the purpose of the present invention is to generate a compact model for the target device using a neural compact modeling method. In generating a compact model for the target device, the voltage datasets 21 and 25 and the drain currents 23 and 27 of the source device are used. Neural compact modeling refers to performing compact modeling using a neural network.

The number of pieces of data of the voltage datasets 71 and 75 and the drain currents 73 and 77 of the target device is less than the number of pieces of data of the voltage datasets 21 and 25 and the drain currents 23 and 27 of the source device.

Therefore, in the present invention, in order to generate a compact model for the target device with limited data, the neural network 100 is first trained using the voltage datasets 21 and 25 and the drain currents 23 and 27 of the source device.

The neural network 100 includes an encoder 20 and a decoder 60.

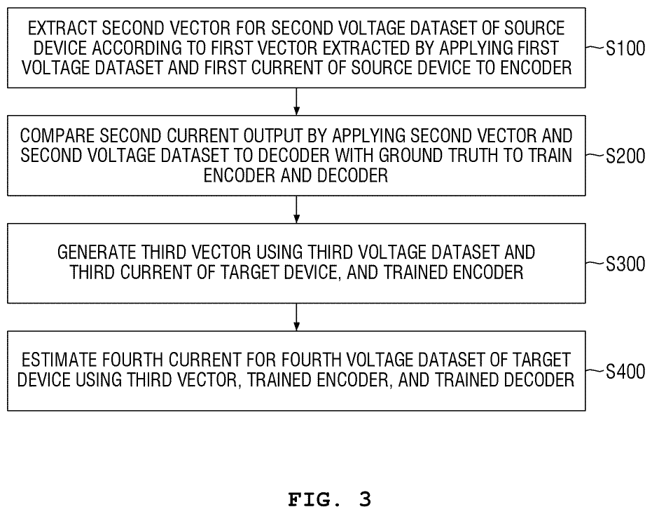

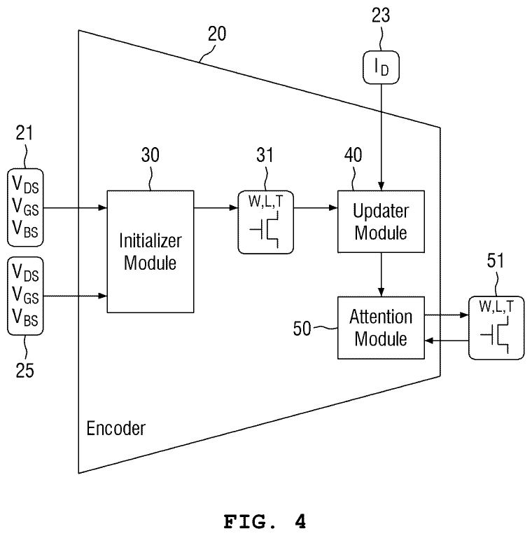

FIG. 3 illustrates a flowchart for describing a neural compact modeling method according to an embodiment of the present invention.

Referring to FIGS. 1 to 3, the processor 11 extracts an updated second vector 51 for the second voltage dataset 25 of the source device according to a first vector 31 in FIG. 4 extracted by applying the first voltage dataset 21 and the first current 23 of the source device to the encoder 20 (S100). The extraction refers to output. The first current 23 is the drain current of the source device. That is, the processor 11 compares the first vector 31 in FIG. 4, which is extracted by applying the first voltage dataset 21 and the first current 23 of the source device to the encoder 20, with the second vector 51 generated by applying the second voltage dataset 25 of the source device to the encoder 20, to extract an updated second vector 51. In other words, the processor 11 extracts the updated second vector 51 from the first vector 31 in FIG. 4, which is extracted by applying the first voltage dataset 21 and the first current 23 of the source device to the encoder 20, the first voltage dataset 21 of the source device, and the second vector 51 generated by applying the second voltage dataset 25 of the source device to the encoder 20. Applying the first vector 31 in FIG. 4 to the encoder 20 means that the updated second vector 51 is extracted using the first vector 31 in FIG. 4. The updated second vector 51 may be used in Equation 2 below.

The first vector 31 is a function that maps the first voltage dataset 21 to data on a width, a length, and a temperature of the source device. The second vector 51 is a function that maps the second voltage dataset 25 to data on a width, a length, and a temperature of the source device.

The processor 11 compares the second current 27 output by applying the second vector 51 and the second voltage dataset 25 to the decoder 60 with a ground truth to train the encoder 20 and the decoder 60 (S200). The second current 27 is the drain current of the source device. The encoder 20 and the decoder 60 are trained such that the difference between the second current 27 and the ground truth is minimized.

The processor 11 generates a third vector 91 using the third voltage dataset 71 and the third current 73 of the target device, and the trained encoder 80 (S300). That is, the processor 11 applies the third voltage dataset 71 and the third current 73 of the target device to the trained encoder 80 to generate the third vector 91.

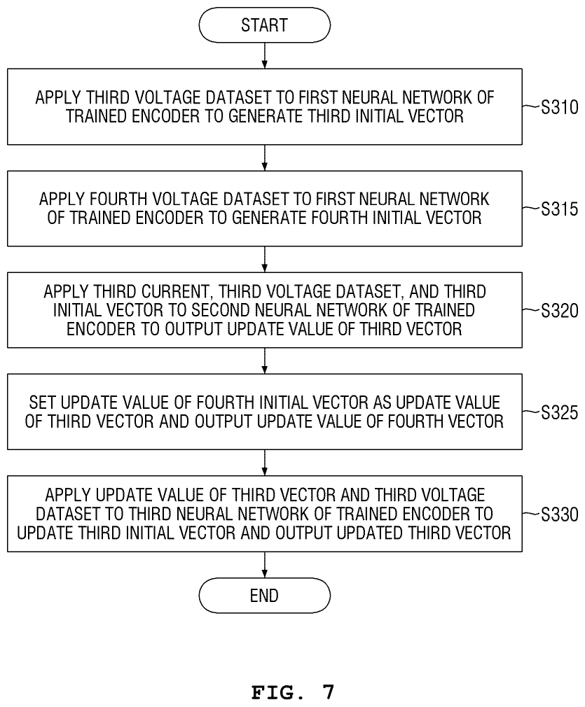

The processor 11 estimates the fourth current 77 for the fourth voltage dataset 75 of the target device using the third vector 91 in FIG. 6, the trained encoder 80, and the trained decoder 130 (S400). The processor 11 applies the third vector 91 in FIG. 6, the third voltage dataset 71, and the fourth voltage dataset 75 to the trained encoder 80 to output an updated fourth vector 121, and applies the updated fourth vector 121 and the fourth voltage dataset 75 to the trained decoder 130 to estimate the fourth current 77 for the fourth voltage dataset 75 of the target device. Applying the third vector 91 in FIG. 6 to the trained encoder 80 means that the updated fourth vector 121 is generated using the third vector 91 in FIG. 6. The updated fourth vector 121 may be generated using Equation 2 below.

FIG. 4 illustrates an internal block diagram of an encoder of a neural network for the source device shown in FIG. 2.

Referring to FIGS. 1 to 4, the encoder 20 includes an initial vector generation module 30, an updater module 40, and an attention module 50.

Each of the initial vector generation module 30, the updater module 40, and the attention module 50 is implemented as a multilayer perceptron (MLP).

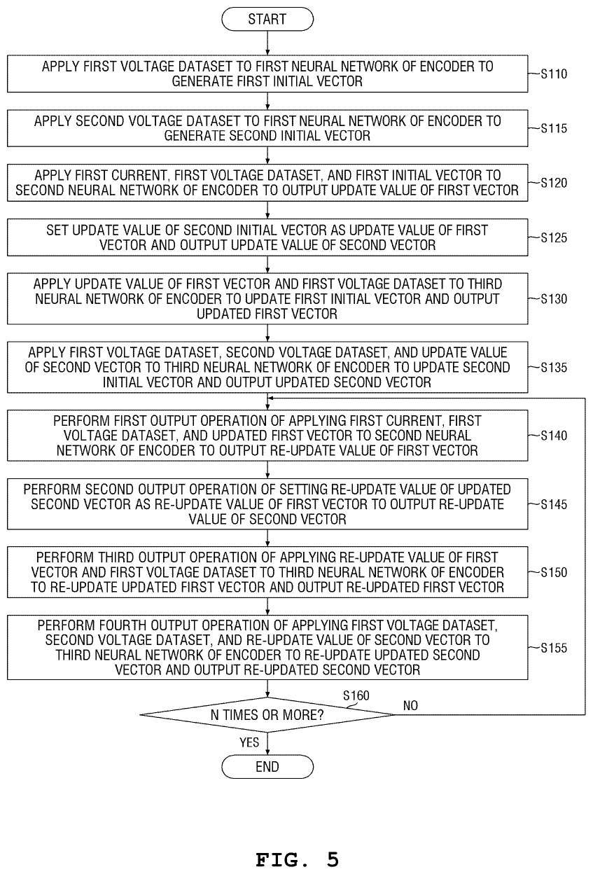

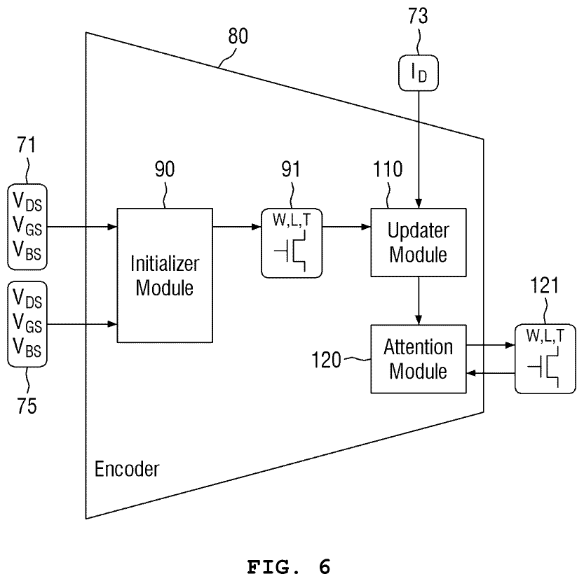

FIG. 5 illustrates a flowchart for describing in detail the operation (S100) of extracting the second vector shown in FIG. 3.

Referring to FIGS. 1 to 5, the initial vector generation module 30 receives the first voltage dataset 21 of the source device or the second voltage dataset 25 of the source device to generate an initial vector of the first vector 31 or an initial vector of the second vector 51.

The first voltage dataset 21 includes a drain-source voltage VDS, a gate-source voltage Vos, and a bulk-source voltage VBS for the source device. The second voltage dataset 25 includes a drain-source voltage VDS, a gate-source voltage Vos, and a bulk-source voltage VBS for the source device. The first voltage dataset 21 and the first current 23 may be referred to as a support set. The second voltage dataset 25 and the second current 27 may be referred to as a query set. The current and voltage datasets for the width, length, and temperature of the source device are defined as a task. A plurality of tasks may be used. Tasks may be divided into a support set and a query set.

The first vector 31 or the second vector 51 is a vector expressed by compressing data on the width, length, and temperature of the source device. The first vector 31 or the second vector 51 is not a fixed value but is in the form of a function having a value that changes according to the voltage. Therefore, by using the form of a function, the current characteristics that change in various voltage regions (e.g., a linear region, a saturation region, and a cut-off region) may be more appropriately reflected.

The initial vector of the first vector 31 or the initial vector of the second vector 51 means that the first vector 31 or the second vector 51 is initialized. That is, the processor 11 applies the first voltage dataset 21 to the first neural network of the encoder 20 to generate the first initial vector 31 (S110). The processor 11 applies the second voltage dataset 25 to the first neural network of the encoder 20 to generate the second initial vector 51 (S115). The first neural network is the initial vector generation module 30. The first initial vector 31 is a vector obtained by initializing the first vector 31. The second initial vector 51 is a vector obtained by initializing the second vector 51.

The updater module 40 compares the first voltage dataset 21, the first vector 31, and the first current 23 to output an update value of the first vector 31 (S120). Comparing the first voltage dataset 21, the first vector 31, and the first current 23 means applying the first voltage dataset 21, the first vector 31, and the first current 23 to the neural network to output an update value of the first vector 31. The neural network is an updater module 40. The update value of the first vector 31 is a specific value of the function. That is, the processor 11 applies the first current 23, the first voltage dataset 21, and the first initial vector of the first vector 31 to the second neural network of the encoder 20 to output the update value of the first vector 31. The second neural network is the updater module 40.

The attention module 50 compares the first voltage dataset 21 with the second voltage dataset 25 to output an updated second vector 25 from the update value of the first vector 21.

Hereinafter, the operations of the attention module 50 will be described in detail.

The processor 11 sets an update value of the second initial vector 25 as the update value of the first vector 21 and outputs an update value of the second vector 25 (S125). That is, the processor 11 sets the update value of the first vector 21 as the update value of the second initial vector 25 and outputs the update value of the second vector 25. The update value of the second vector 25 is set with the update value of the first vector 21.

The second initial vector 25 is a vector obtained by initializing the second vector 25. The outputting of the update value of the second vector 25 may be performed in the attention module 50.

The processor 11 applies the update value of the first vector 21 and the first voltage dataset 21 to the third neural network of the encoder 20 to update the first initial vector 31 and output an updated first vector 31 (S130). The third neural network is the attention module 50. The updated first vector 31 may be expressed as in the following Equation 1.

Updated support representation=initial support representation+alpha*ATTENTION(querys=support V, keys-support V, values=support representation initial update value) [Equation 1]

In Equation 1, the updated support representation represents the updated first vector 31, the initial support representation represents the first initial vector 31, which is a vector obtained by initializing the first vector 31, alpha represents a learning rate, ATTENTION represents an MLP, the queries, the keys, and the values represent vectors in the attention of the neural network, support V represents the first voltage dataset 21, and the support representation initial update value represents the update value of the first vector 31.

The processor 11 applies the first voltage dataset 21, the second voltage dataset 25, and the update value of the second vector 51 to the third neural network of the encoder 20 to update the second initial vector 51 and outputs an updated second vector 51 (S135). Although the first voltage dataset 21 and the second voltage dataset 25 are not input to the attention module 50 in FIG. 3, it should be understood that the first voltage dataset 21 is actually input to the attention module 50. The updated second vector 51 may be expressed as shown in the following Equation 2.

Updated query representation=initial query representation+alpha*ATTENTION(querys=query V, keys=support V, values=query representation initial update value) [Equation 2]

In Equation 2, the updated query representation represents the updated second vector 51, the initial query representation represents the second initial vector 51 which is a vector obtained by initializing the second vector 51, alpha represents a learning rate, ATTENTION represents an MLP, the queries, the keys, and the value represent vectors in the attention of the neural network, query V represents the second voltage dataset 25, support V represents the first voltage dataset 21, and the query representation initial update value represents the update value of the second vector 51.

The processor 11 performs a first output operation of applying the first current 23, the first voltage dataset 21, and the updated first vector 31 to the second neural network 40 of the encoder 20 to output a re-update value of the first vector 31 (S140).

The processor 11 performs a second output operation of setting a re-update value of the updated second vector 51 as the re-update value of the first vector 31 to output a re-update value of the second vector 51 (S145). That is, the processor 11 performs a second output operation of setting a re-update value of the first vector 31 as the re-update value of the updated second vector 51 to output the re-update value of the second vector 51. The re-update value of the updated second vector 51 is set with the re-update value of the first vector 31.

The outputting of the update value of the second vector 25 may be performed in the attention module 50.

The processor 11 performs a third output operation of applying the re-update value of the first vector 31 and the first voltage dataset 21 to the third neural network 50 of the encoder 20 to re-update the updated first vector 31 and output the re-updated first vector 31 (S150).

The processor 11 performs a fourth output operation of applying the first voltage dataset 21, the second voltage dataset 25, and the re-update value of the second vector 51 to the third neural network 50 of the encoder 20 to re-update the updated second vector 51 and output the re-updated second vector 51 (S155). That is, the re-updated second vector 51 is extracted.

The processor 11 repeatedly performs the first output operation (S140), the second output operation (S145), the third output operation (S150), and the fourth output operation (S155) an arbitrary number of times. That is, the processor 11 determines whether the first output operation (S140), the second output operation (S145), the third output operation (S150), and the fourth output operation (S155) have been repeatedly performed N times (N is a natural number) or more. The processor 11, upon determining that the operations have been repeatedly performed N times or more, terminates the operations. Therefore, even when there is no current value for the second voltage dataset 25, the second vector 51 for the second voltage dataset 25 may be extracted. The arbitrary number of times may be set arbitrarily.

In the process (S110 to S155) of performing the operation of extracting the second vector 51, parameters (weights and bias) of the encoder 20 and parameters of the decoder 60 are not updated. That is, the operation of extracting the second vector 51 is not performed by backpropagation in a training operation of the neural network 100.

After the second vector 51 for the second voltage dataset 25 of the source device is extracted (S100), the processor 11 compares a second current 27 output by applying the second vector 51 and the second voltage dataset 25 to the decoder 60 with a ground truth to train the encoder 20 and the decoder 60 (S200). Backpropagation is performed. The parameters (weights and biases) of the encoder 20 and the decoder 60 are updated.

After the encoder 20 and the decoder 60 are trained (S200), the processor 11 generates a third vector 91 in FIG. 6 using the third voltage dataset 71 and the third current 73 of the target device, and the trained encoder 80 (S300).

The neural network 200 includes the trained encoder 80 and the trained decoder 130. The trained encoder 80 and the trained decoder 130 are the encoder 20 and the decoder 60 trained in the neural network 100. That is, the encoder 20 and the decoder 60 having parameters updated through training in the neural network 100 are the trained encoder 80 and the trained decoder 130.

FIG. 6 illustrates an internal block diagram of the encoder of the neural network for the target device shown in FIG. 2.

Referring to FIG. 2 and FIG. 6, the encoder 80 includes an initial vector generation module 90, an updater module 110, and an attention module 120.

Each of the initial vector generation module 90, the updater module 110, and the attention module 120 is implemented as an MLP. The initial vector generation module 90, the updater module 110, and the attention module 120 are modules obtained by updating parameters of the initial vector generation module 30, the updater module 40, and the attention module 50 through training of the neural network 100.

FIG. 7 illustrates a flowchart for describing in detail the operation (S300) of extracting the third vector shown in FIG. 3.

Referring to FIGS. 1 to 7, the processor 11 applies the third voltage dataset 71 to the first neural network of the trained encoder 80 to generate a third initial vector 91 (S310). The first neural network represents a trained initial vector generation module 90.

The processor 11 applies the fourth voltage dataset 75 to the first neural network 90 of the trained encoder 80 to generate a fourth initial vector 121 (S315).

The third initial vector 91 is a vector obtained by initializing the third vector 91. The fourth initial vector 121 is a vector obtained by initializing the fourth vector 121.

The third vector 91 or the fourth vector 121 is a vector expressed by compressing data on the width, length, and temperature of the target device. The third vector 91 or the fourth vector 121 is not a fixed value but is in the form of a function having a value that changes according to the voltage.

The third voltage dataset 71 includes a drain-source voltage VDS, a gate-source voltage Vos, and a bulk-source voltage VBS for the target device. The fourth voltage dataset 75 includes a drain-source voltage VDS, a gate-source voltage Vos, and a bulk-source voltage VBS for the target device.

The third voltage dataset 71 and the third current 73 may be referred to as a support set. The third current 73 is a drain current for the target device.

The fourth voltage dataset 75 and the fourth current 77 may be referred to as a query set. The fourth current 77 is a drain current for the target device.

The amount of data of the third voltage dataset 71 and the third current 73 for the target device is limited. The amount of data of the third voltage dataset 71 and the third current 73 for the target device is less than the amount of data of the first voltage dataset 21 and the first current 23 for the source device.

The processor 11 applies the third current 73, the third voltage dataset 71, and the third initial vector 91 to the second neural network of the trained encoder 80 to output an update value of the third vector 91 (S320). The second neural network represents a trained updater module 110. The update value of the third vector 91 is a specific value of the function.

The processor 11 sets an update value of the fourth initial vector 121 as the update value of the third vector 91 and outputs an update value of the fourth vector 121 (S325).

That is, the processor 11 sets the update value of the third vector 91 as an update value of the fourth initial vector 121 and outputs an update value of the fourth vector 121. The update value of the fourth vector 121 is set with the update value of the third vector 91.

The outputting of the update value of the fourth vector 121 may be performed in the trained attention module 120. The update value of the fourth vector 121 is a specific value of the function.

The processor 11 applies the update value of the third vector 91 and the third voltage dataset 71 to the third neural network 120 of the trained encoder 80 to update the third initial vector 91 and output an updated third vector 91 (S330). The operation of outputting the updated third vector 91 (S330) may employ the Equation 1.

In this case, in the Equation 1, the updated support representation represents the updated third vector 91, the initial support representation represents the third initial vector 91 which is a vector obtained by initializing the third vector 91, alpha represents a learning rate, ATTENTION represents an MLP, the queries, the keys, and the value represent vectors in the attention of the neural network, support V represents the third voltage dataset 71, and the support representation initial update value represents an update value of the third vector 91.

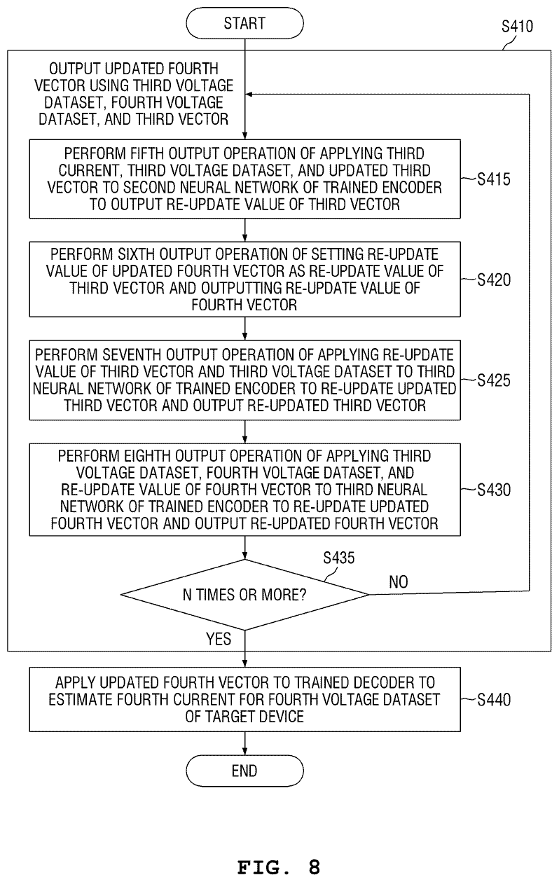

FIG. 8 illustrates a flowchart for describing in detail the operation (S400) of estimating the fourth current shown in FIG. 3.

Referring to FIGS. 1 to 8, the operation (S400) of estimating the fourth current includes an operation (S410) of outputting the fourth vector and an operation (S440) of estimating the fourth current.

The processor 11 outputs an updated fourth vector 121 using the third voltage dataset 71, the fourth voltage dataset 75, and the third vector 91 (S410).

The operation (S410) of outputting the updated fourth vector 121 may employ the Equation 2. In this case, in Equation 2, the updated query representation represents the updated fourth vector 121, the initial query representation represents the fourth initial vector 121 which is a vector obtained by initializing the fourth vector 121, alpha represents a learning rate, ATTENTION represents an MLP, the queries, the keys, and the value represent vectors in the attention of the neural network, query V represents the fourth voltage dataset 75, support V represents the third voltage dataset 71, and the query representation initial update value represents the update value of the fourth vector 121.

The processor 11, according to the third vector 91 extracted by applying the third voltage dataset 71 and the third current 73 to the trained encoder 80, outputs an updated fourth vector 121 for the fourth voltage dataset 75 of the target device. That is, the processor 11 compares the third vector 91, which is extracted by applying the third voltage dataset 71 and the third current 73 of the target device to the trained encoder 80, with the fourth vector 121, which is generated by applying the fourth voltage dataset 75 of the target device to the trained encoder 80, to extract the updated fourth vector 121. In other words, the processor 11 extracts the updated fourth vector 121 from the third vector 91, which is extracted by applying the third voltage dataset 71 and the third current 73 of the target device to the trained encoder 80, the third voltage dataset 71 of the target device, and the fourth vector 121, which is generated by applying the fourth voltage dataset 75 of the target device to the trained encoder 80. Applying the third vector 91 to the trained encoder 80 means that the updated fourth vector 121 is extracted using the third vector 91. The updated fourth vector 121 is generated using the mathematical expression 2 above.

Hereinafter, detailed operations for outputting the fourth vector 121 will be described.

The operation (S410) of outputting the fourth vector 121 includes a fifth output operation (S415), a sixth output operation (S420), a seventh output operation (S425), an eighth output operation (S430), and a determination operation (S435).

The processor 11 performs a fifth output operation of applying the third current 73, the third voltage dataset 71, and the updated third vector 91 to the second neural network 110 of the trained encoder 80 to output a re-update value of the third vector 91 (S415). The second neural network 110 is a trained updater module.

The processor 11 performs a sixth output operation of setting a re-update value of the updated fourth vector 121 as the re-update value of the third vector 91 and outputting the re-update value of the fourth vector 121 (S420). That is, the processor 11 performs a sixth output operation of setting the re-update value of the third vector 91 as a re-update value of the updated fourth vector 121 and outputting the re-update value of the fourth vector 121. The re-update value of the fourth vector 121 is set with the re-update value of the third vector 91.

The outputting of the re-update value of the fourth vector 121 may be performed in the attention module 120.

The processor 11 performs a seventh output operation of applying the re-update value of the third vector 91 and the third voltage dataset 71 to the third neural network 120 of the trained encoder 80 to re-update the updated third vector 91 and output the re-updated third vector 91 (S425).

The processor 11 performs an eighth output operation of applying the third voltage dataset 71, the fourth voltage dataset 75, and the re-update value of the fourth vector 121 to the third neural network 120 of the trained encoder 80 to re-update the updated fourth vector 121 and output the re-updated fourth vector 121 (S430). That is, the re-updated fourth vector 121 is extracted.

The processor 11 repeatedly performs the fifth output operation (S415), the sixth output operation (S420), the seventh output operation (S425), and the eighth output operation (S430) an arbitrary number of times. That is, the processor 11 determines whether the fifth output operation (S415), the sixth output operation (S420), the seventh output operation (S425), and the eighth output operation (S430) have been repeatedly performed M times (M is a natural number) or more (S435). When the processor 11 determines that the operations have been repeatedly performed M times or more, the processor 11 terminates the operations. The arbitrary number of times may be set arbitrarily.

The processor 11 applies the updated fourth vector 121 and the fourth voltage dataset 75 to the trained decoder 130 to estimate the fourth current 77 for the fourth voltage dataset 75 of the target device (S440).

There is no separate training process for the neural network 200. In the case of conventional transfer learning, fine tuning is required. In the case of Korean Registered Patent No. 10-2285516, referring to paragraph number [0085], parameters of a second neural network 175 are updated. Fine tuning, in which a backpropagation operation is performed, is required for the second neural network 175. However, in the case of the present invention, separate fine tuning is not performed on the neural network 200. Therefore, the drain current of the target device may be estimated faster than transfer learning.

The table below shows compact modeling methods using three different techniques. Random initialization is a compact modeling method using a single neural network. In other words, random initialization is a method in which a single neural network is randomly initialized and trained using limited data of a target device. Transfer learning is a compact modeling method according to Korean Registered Patent No. 10-2285516. Meta learning is a compact modeling method according to the present invention.

In Table 1 below, a pretraining time is a training time of the neural network 100 in the present invention. In the case of Korean Registered Patent No. 10-2285516, a pretraining time is a training time of a neural network 160. An adaptation time is a time required until the neural network 200 is prepared to estimate the current of the target device in the present invention. In the case of Korean Registered Patent No. 10-2285516, an adaptation time is a time required until backpropagation is completed for a neural network 175 or a neural network 185. In the present invention, the backpropagation operation of the neural network 200 is not performed.

Referring to Table 1 below, it can be seen that the present invention requires a shorter adaptation time and has fewer errors compared to transfer learning.

TABLE 1

| | Random | Transfer | | |
|---|---|---|---|---|
| | initialization | learning | Meta learning | |
| Pretraining time | N/A | 646 sec | 17 | hours |
| Adaptation time | 538 sec | 186 sec | 1 | sec |

| (per W/L/T) | | | |
|---|---|---|---|
| Relative linear | 22.9 | 4.3 | 2.3 |
| error (%) | | | |
| Relative log | 1.56 | 0.40 | 0.11 |
| error (%) | | | |

The present invention may increase the accuracy of a neural compact model or an artificial neural network (ANN)-based compact model using meta-learning. This is useful when the amount of data of a target device is limited.

While the present invention has been described with reference to embodiments shown in the drawings to aid in the understanding of the present invention, this is merely illustrative, and it will be appreciated by those skilled in the art that various modifications and other equivalent embodiments are possible. Therefore, the truth technical scope of protection of the present invention should be defined by the following claims.

1. A neural compact modeling method, which is performed by a processor, comprising:
extracting a second vector for a second voltage data set of a source device according to a first vector extracted by applying a first voltage data set and a first current of the source device to an encoder;
comparing a second current output by applying the second vector and the second voltage data set to a decoder with a ground truth to train the encoder and the decoder;
generating a third vector using a third voltage data set and a third current of a target device, and the trained encoder; and
estimating a fourth current for a fourth voltage data set of the target device using the third vector, the trained encoder, and the trained decoder.

2. The neural compact modeling method of claim 1, wherein the encoder includes:
an initial vector generation module that generates an initial vector of the first vector or the second vector;
an updater module that compares the first voltage data set, the first vector, and the first current to output an update value of the first vector; and
an attention module that compares the first voltage data set with the second voltage data set to output an updated second vector from the update value of the first vector.

3. The neural compact modeling method of claim 1, wherein the extracting of the second vector includes:
applying the first voltage data set to a first neural network of the encoder to generate a first initial vector;
applying the second voltage data set to the first neural network of the encoder to generate a second initial vector;
applying the first current, the first voltage data set, and the first initial vector to a second neural network of the encoder to output an update value of the first vector;
setting an update value of the second initial vector as the update value of the first vector to output an update value of the second vector;
applying the update value of the first vector and the first voltage data set to a third neural network of the encoder to update the first initial vector and output an updated first vector; and
applying the first voltage data set, the second voltage data set, and the update value of the second vector to the third neural network of the encoder to update the second initial vector and output an updated second vector.

4. The neural compact modeling method of claim 3, further comprising:
performing a first output operation of applying the first current, the first voltage data set, and the updated first vector to the second neural network of the encoder to output a re-update value of the first vector;
performing a second output operation of setting a re-update value of the updated second vector as the re-update value of the first vector to output the re-update value of the second vector;
performing a third output operation of applying the re-update value of the first vector and the first voltage data set to the third neural network of the encoder to re-update the updated first vector and output the re-updated first vector; and
performing a fourth output operation of applying the first voltage data set, the second voltage data set, and the re-updated value of the second vector to the third neural network of the encoder to re-update the updated second vector and outputting the re-updated second vector.

5. The neural compact modeling method of claim 4, wherein the first output operation, the second output operation, the third output operation, and the fourth output operation are repeatedly performed an arbitrary number of times.

6. The neural compact modeling method of claim 1, wherein the second vector is expressed by compressing data on a width, a length, and a temperature of the source device.

7. The neural compact modeling method of claim 1, wherein the second vector is a function that maps the second voltage data set to data on a width, a length, and a temperature of the source device.

8. The neural compact modeling method of claim 1, wherein the second voltage data set is a drain-source voltage, a gate-source voltage, and a bulk-source voltage.

9. The neural compact modeling method of claim 1, wherein, in a process of extracting the second vector, parameters of the encoder and parameters of the decoder are not updated.

10. The neural compact modeling method of claim 1, wherein the generating of the third vector includes:
applying the third voltage data set to a first neural network of the trained encoder to generate a third initial vector;
applying the fourth voltage data set to the first neural network of the trained encoder to generate a fourth initial vector;
applying the third current, the third voltage data set, and the third initial vector to a second neural network of the trained encoder to output an update value of the third vector;
setting an update value of the fourth initial vector as the update value of the third vector to output an update value of a fourth vector; and
applying the update value of the third vector and the third voltage data set to a third neural network of the trained encoder to update the third initial vector and output an updated third vector.

11. The neural compact modeling method of claim 10, wherein the estimating of the fourth current includes:
outputting an updated fourth vector using the third voltage data set, the fourth voltage data set, and the third vector; and
applying the updated fourth vector to the trained decoder to estimate the fourth current for the fourth voltage data set of the target device.

12. A computing device comprising:
a memory that stores instructions; and
a processor that executes the instructions,
wherein the instructions are implemented to:
extract a second vector for a second voltage data set of a source device according to a first vector extracted by applying a first voltage data set and a first current of the source device to an encoder;
compare a second current output by applying the second vector and the second voltage data set to a decoder with a ground truth to train the encoder and the decoder;
generate a third vector using a third voltage data set and a third current of a target device, and the trained encoder; and
estimate a fourth current for a fourth voltage data set of the target device using the third vector, the trained encoder, and the trained decoder.

13. The computing device of claim 12, wherein the encoder includes:
an initial vector generation module that generates an initial vector of the first vector or the second vector;
an updater module that compares the first voltage data set, the first vector, and the first current and outputs an update value of the first vector; and
an attention module that compares the first voltage data set and the second voltage data set to output an updated second vector from the update value of the first vector.

14. The computing device of claim 12, wherein the second vector is expressed by compressing data on a width, a length, and a temperature of the source device.

15. The computing device of claim 12, wherein the second vector is a function that maps the second voltage data set to data on a width, a length, and a temperature of the source device.

16. The computing device of claim 12, wherein the second voltage data set is a drain-source voltage, a gate-source voltage, and a bulk-source voltage.

17. The computing device of claim 13, wherein, in a process of extracting the second vector, parameters of the encoder and parameters of the decoder are not updated.

18. The computing device of claim 12, wherein the instructions to generate the third vector are implemented to:
apply the third voltage data set to a first neural network of the trained encoder to generate a third initial vector;
apply the fourth voltage data set to the first neural network of the trained encoder to generate a fourth initial vector;
apply the third current, the third voltage data set, and the third initial vector to a second neural network of the trained encoder to output an update value of the third vector;
set an update value of the fourth initial vector as the update value of the third vector to output an update value of a fourth vector; and
apply the update value of the third vector and the third voltage data set to a third neural network of the trained encoder to update the third initial vector and output an updated third vector.

19. The computing device of claim 18, wherein the instructions to estimate the fourth current are implemented to:
output an updated fourth vector using the third voltage data set, the fourth voltage data set, and the third vector; and
apply the updated fourth vector to the trained decoder to estimate the fourth current for the fourth voltage data set of the target device.
